(19) United States
(12) Patent Application Publication
(10) Pub. No.: US 2024/0327664 A1
(43) Pub. Date: Oct. 3, 2024

(54) AQUEOUS INK, INK CARTRIDGE AND INK JET RECORDING METHOD

(71) Applicant: CANON KABUSHIKI KAISHA, Tokyo (JP)

(72) Inventors: MIKIO SANADA, Kanagawa (JP); YOSHIYUKI KANEKO, Kanagawa (JP); Yoshihisa Yamashita, Osaka (JP); SHOICHI TAKEDA, Kanagawa (JP); HIDEKI YAMAKAMI, Kanagawa (JP)

(21) Appl. No.: 18/617,399

(22) Filed: Mar. 26, 2024

(30) Foreign Application Priority Data
Mar. 28, 2023 (JP) 2023-052458
Feb. 29, 2024 (JP) 2024-030008

(51) Int. Cl. C09D 11/322; B41J 2/175; C08K 3/22; C08K 9/02; C09D 11/107; C09D 11/36; C09D 11/38

(52) U.S. Cl. CPC C09D 11/322; B41J 2/17513; B41J 2/17523; C09D 11/107; C09D 11/36; C09D 11/38; C08K 2003/2241; C08K 9/02

(57) ABSTRACT

An aqueous ink for ink jet recording includes a titanium oxide particle, a resin particle and a water-soluble organic solvent. The titanium oxide particle includes titanium oxide having a surface at least a portion of which is covered with alumina and silica and, in the aqueous ink, a content of the titanium oxide particle (T (% by mass)), a content of the resin particle (E (% by mass)) and a content of the water-soluble organic solvent (S (% by mass)) satisfy relations of a formula (1) and a formula (2) below:

$$E / T \geq 0.5 \qquad ( 1 )$$

$$0.3 \leq S / ( T + E ) \leq 0.7 . \qquad ( 2 )$$

### BACKGROUND

### Field of the Disclosure

The present disclosure relates to an aqueous ink, an ink cartridge and an ink jet recording method.

### Description of the Related Art

In recent years, in the cases of outputting advertisements and exhibits using recording media such as paper and resin films, ink jet recording apparatuses have come to be widely used. For example, in order to form sharp color images even on transparent recording media, black and basic color inks (hereafter, these may be collectively referred to as color inks) are used in combination with a white ink. Specifically, a background color treatment is performed by applying a white ink in advance to an area of a transparent recording medium including a region where an image is to be recorded and color inks are applied onto the background color; alternatively, a recording method of applying the inks in reverse order (what is called, the back printing) is used.

The color material of the white ink widely employed is titanium oxide because it is available at low costs and has good properties as the white ink such as whiteness and the hiding property. On the other hand, titanium oxide is a metallic oxide and has a larger specific gravity than pigments used for basic color inks, black inks and the like. In order to improve the whiteness and the hiding property of recorded images, in general, a method of increasing the ink application amount and a method of increasing the content of the titanium oxide particle in the ink may be employed. The former method involves an increase in the drying time, which leads to degradation of the fixability. On the other hand, the latter method involves, in order to achieve stable dispersion of titanium oxide having a large specific gravity, adjustments of the contents of the water-soluble organic solvent, the dispersant and the like in the ink in accordance with the amount of titanium oxide added, which affects the ejection properties.

In order to reduce the drying time of images and to improve the image quality, Japanese Patent Laid-Open No. 2021-154547 proposes adjustment of the content of the water-soluble organic solvent in the ink and adjustment of the air flow rate during drying. In addition, Japanese Patent Laid-Open No. 2017-109485 proposes an ink jet recording method using a first ink and a second ink in which the content of the water-soluble organic solvent and the content of the solid content are adjusted.

The inventors of the present disclosure used the aqueous inks used in the ink jet recording methods of Japanese Patent Laid-Open No. 2021-154547 and Japanese Patent Laid-Open No. 2017-109485 to record images and studied various performances. As a result, they have found that both of the aqueous inks described in Japanese Patent Laid-Open No. 2021-154547 and Japanese Patent Laid-Open No. 2017-109485 have an insufficient hiding property and insufficient scratch resistance and have room for improvements. An increase in the ink application amount improves the hiding property, but involves an increase in the ink drying time, which results in degradation of the fixability. An increase in the content of the titanium oxide in the ink involves an increase in the content of the water-soluble organic solvent performed from the viewpoint of the ejection property, which increases the ink drying time and similarly results in degradation of the fixability.

### SUMMARY OF THE DISCLOSURE

Thus, the present disclosure provides a titanium oxide-containing aqueous ink for ink jet recording in which fixability, a hiding property and scratch resistance are all sufficient, an ink cartridge and an ink jet recording method that use the aqueous ink.

Specifically, an aqueous ink according to an embodiment of the present disclosure is an aqueous ink for ink jet recording including a titanium oxide particle, a resin particle and a water-soluble organic solvent, wherein the titanium oxide particle includes titanium oxide having a surface at least a portion of which is covered with alumina and silica and, in the aqueous ink, a content of the titanium oxide particle (T (% by mass)), a content of the resin particle (E (% by mass)) and a content of the water-soluble organic solvent (S (% by mass)) satisfy relations of a formula (1) and a formula (2) below:

$$E / T \geq 0.5 \qquad ( 1 )$$

$$0.3 \leq S / ( T + E ) \leq 0.7 . \qquad ( 2 )$$

Further features of the present disclosure will become apparent from the following description of exemplary embodiments with reference to the attached drawings.

### BRIEF DESCRIPTION OF THE DRAWINGS

FIG. 1 is a sectional view schematically illustrating an ink cartridge according to an embodiment of the present disclosure.

FIG. 2A is a perspective view schematically illustrating a main part of an ink jet recording apparatus used for an ink jet recording method according to an embodiment of the present disclosure and FIG. 2B is a perspective view schematically illustrating a head cartridge of the ink jet recording apparatus.

### DESCRIPTION OF THE EMBODIMENTS

Hereinafter, the present disclosure will be described further in detail with reference to some embodiments. In the present disclosure, when the compound is a salt, such a salt dissociates into ions in an ink; however, for convenience, the ink is described as “containing the salt”. Titanium oxide and titanium oxide particles may be simply referred to as “pigments”. An aqueous ink for ink jet recording may be simply referred to as “inks”. Property values are values at room temperature (25° C.) unless otherwise specified. Inks according to embodiments of the present disclosure are aqueous inks containing water and, for convenience, are regarded as having a specific gravity of 1.00 g/mL.

As described above, in order to improve image whiteness or the hiding property, the ink application amount or the titanium oxide content may be increased; however, these methods both have drawbacks. The drawbacks cannot be resolved with use of the aqueous inks used in the ink jet recording methods described in Japanese Patent Laid-Open No. 2021-154547 and Japanese Patent Laid-Open No. 2017-109485. The inventors of the present disclosure studied a method that is different from the adjustment of the ink application amount and that efficiently improves the hiding property. As a result, they have found that, in addition to simply increasing the titanium oxide content in the ink, it is important to adjust the ratio between titanium oxide and a particle component such as a resin particle.

Specifically, an ink according to an embodiment of the present disclosure has the following features. First, a titanium oxide particle that is titanium oxide having a surface at least a portion of which is covered with alumina and silica is used. The ink further contains a resin particle. In addition, the content of the titanium oxide particle (T (% by mass)), the content of the resin particle (E (% by mass)) and the content of a water-soluble organic solvent (S (% by mass)) satisfy the relations of a formula (1) and a formula (2) below. The mechanism by which such features provide fixability, a hiding property and scratch resistance that are all sufficient is inferred by the inventors of the present disclosure, which will be described below.

$$E / T \geq 0.5 \qquad ( 1 )$$

$$0.3 \leq S / ( T + E ) \leq 0.7 \qquad ( 2 )$$

The ink contains, in addition to the titanium oxide particle, the resin particle. The use of the ink containing the resin particle provides an image having high scratch resistance. The ink satisfies the above-described formula (1) and formula (2). The formula (1) means that, in the ink, the mass ratio of the content of the resin particle (% by mass) to the content of the titanium oxide particle (% by mass) is 0.50 times or more. The formula (2) means that, in the ink, the mass ratio of the content of the water-soluble organic solvent (% by mass) to the contents of the titanium oxide particle and the resin particle (% by mass) is 0.30 times or more to 0.70 times or less.

The mass ratio of the content of the resin particle to the content of the titanium oxide particle is set to 0.50 times or more, so that the resin particle tends to enter gaps between the titanium oxide particles being aggregated. This facilitates occurrence of light scattering. An image is recognized as being white as a result of sufficient light scattering; thus, facilitation of occurrence of light scattering improves the hiding property of the image. When the mass ratio is less than 0.50 times, the content of the resin particle is excessively low and light scattering is insufficient, so that the image does not have the hiding property. In addition, the resin particle tends not to be uniformly distributed over the whole pigment layer formed and the image does not have scratch resistance.

The formula (2) is the content relation between the water-soluble organic solvent, and the titanium oxide particle and the resin particle, namely, the particle component. The content relation is set to be within the range, so that fixability, the hiding property and scratch resistance are all sufficient. When S/(T+E) is less than 0.30 times, the content of the water-soluble organic solvent relative to the particle component is excessively low, so that the liquid component of the ink evaporates within the recording head, which tends to destabilize the dispersion state of the particle component. As a result, titanium oxide aggregates within the recording head, so that the ejection property is degraded and the amount of the titanium oxide particle being dispersed in the ink decreases. Thus, the image does not have the hiding property. On the other hand, when S/(T+E) is more than 0.70 times, the content of the water-soluble organic solvent is excessively high, so that the hiding property and fixability are not provided.

### Aqueous Ink

An ink according to an embodiment of the present disclosure is an aqueous ink for ink jet recording containing, in the specified ratios, titanium oxide covered with the specified inorganic oxides, a resin particle and a water-soluble organic solvent. This ink containing titanium oxide, which is a white pigment, can be a white ink. Hereinafter, components constituting the ink according to the embodiment of the present disclosure, properties of the ink and the like will be described in detail.

### Color Material

The ink contains, as a color material (pigment), a titanium oxide particle in which titanium oxide is surface-treated with the specified inorganic oxides. Specifically, the ink contains a titanium oxide particle that is titanium oxide having a surface covered with the specified inorganic oxides. In the ink, the content of the titanium oxide particle (% by mass) is preferably 0.10% by mass or more to 20.00% by mass or less based on the total mass of the ink. More preferably, in the ink, the content of the titanium oxide particle (% by mass) is 1.00% by mass or more to 20.00% by mass or less based on the total mass of the ink. Particularly preferably, in the ink, the content of the titanium oxide particle (% by mass) is 10.00% by mass or more to 20.00% by mass or less based on the total mass of the ink. When the content of the titanium oxide particle is less than 10.00% by mass, the image has an insufficient hiding property in some cases. On the other hand, when the content of the titanium oxide particle is more than 20.00% by mass, the amount of resin particle added is increased in order to impart scratch resistance, which affects the ejection property of the ink in some cases. As a result, the image has an insufficient hiding property in some cases.

Titanium oxide is a white pigment and exists in three crystalline forms of rutile, anatase and brookite. Of these, the rutile titanium oxide can be employed. The industrial production process of the titanium oxide may be the sulfate process or the chloride process; the titanium oxide employed in the embodiment of the present disclosure may be produced by one of the production processes.

The titanium oxide particle preferably has a volume-based 50% cumulative particle size (hereafter, also referred to as average particle size) of 200 nm or more to 500 nm or less. More preferably, the titanium oxide particle has a volume-based 50% cumulative particle size of 200 nm or more to 400 nm or less. The volume-based 50% cumulative particle size (D₅₀) of the titanium oxide particle is the diameter of a particle corresponding to 50% in the particle-size cumulative curve drawn from the smaller particle size side on the basis of the total of the measured volumes of particles. Dso of the titanium oxide particle can be measured under the following conditions: for example, SetZero: 30 seconds, measurements: three times, measurement time: 180 seconds, shape: aspherical and refractive index: 2.60. The particle size distribution measurement apparatus employed can be a particle size analyzer using dynamic light scattering. The measurement conditions and the like are obviously not limited to those described above.

The titanium oxide employed is surface-treated with alumina and silica. The surface treatment is expected to suppress the photocatalytic activity and to improve the dispersibility. In this Specification, “alumina” is the general term for oxides of aluminum such as aluminum oxide. In this Specification, “silica” is the general term for silicon dioxide and substances constituted by silicon dioxide. Most of the alumina and silica covering the titanium oxide are present in the forms of silicon dioxide and aluminum oxide.

The content of titanium oxide (% by mass) in the titanium oxide particle is preferably 90.00% by mass or more based on the total mass of the titanium oxide particle. The content of titanium oxide (% by mass) in the titanium oxide particle is preferably 98.50% by mass or less based on the total mass of the titanium oxide particle.

The mass ratio of the content of alumina (% by mass) in the titanium oxide particle to the content of silica (% by mass) is preferably 0.50 times or more to 1.00 time or less. The content of alumina (% by mass) in the titanium oxide particle is preferably 0.50% by mass or more to 4.00% by mass or less based on the total mass of the titanium oxide particle. More preferably, the content of alumina (% by mass) in the titanium oxide particle is 1.00% by mass or more to 4.00% by mass or less based on the total mass of the titanium oxide particle.

The content of silica (% by mass) in the titanium oxide particle is preferably 1.00% by mass or more to 4.00% by mass or less based on the total mass of the titanium oxide particle. When the content of silica is set within the range, the negative electrostatic repulsive force due to the surface hydroxy group derived from silica is provided. In addition, also in the case of using a silane compound described later, the reactivity to the silane compound is appropriately adjusted and aggregation of the titanium oxide particle can be further suppressed.

The method of measuring the contents of alumina and silica in the titanium oxide particle, namely, the coverage amounts of alumina and silica is, for example, quantitative analysis of aluminum and silicon elements by inductively coupled plasma (ICP) emission spectrometry. In this case, the atoms covering the surface are all assumed to be oxides and the measurement values of aluminum and silicon are converted in terms of oxides, specifically, alumina and silica, to determine the contents. The mass ratio of the content of the aluminum element (% by mass) in the titanium oxide particle measured by inductively coupled plasma emission spectrometry to the content of the silicon element (% by mass) similarly measured is preferably 0.57 times or more to 1.13 times or less. This value is converted in terms of the oxides, specifically, alumina and silica and the mass ratio of the content of alumina (% by mass) to the content of silica (% by mass) in the titanium oxide particle is 0.50 times or more to 1.00 time or less.

The titanium oxide particle is, as described above, surface-treated with alumina and silica. Of these, the titanium oxide particle can be dispersed by the action of at least silica. The titanium oxide particle, which is the titanium oxide covered with alumina and silica, undergoes a change in the surface charge state in response to the pH of the ink. In the pH range ordinarily employed as the ink, the surface hydroxy group derived from silica is negatively charged. Thus, even when titanium oxide particles come close to each other, electrostatic repulsion suppresses aggregation to provide stable dispersion. In the case of an ink described later and containing 0.01% by mass or more of a water-soluble resin other than polyacrylic acid, dispersion due to the action of silica is destabilized. As a result, the image has insufficient fixability in some cases.

The surface treatment process for titanium oxide is, for example, a wet process or a dry process. For example, titanium oxide is dispersed in a liquid medium and subsequently caused to react with surface treatment agents such as sodium aluminate and sodium silicate to perform the surface treatment; the ratio of the surface treatment agents can be appropriately changed to thereby perform adjustment to desired properties. For the surface treatment, in addition to alumina and silica, an inorganic oxide such as zinc oxide or zirconia or an organic material such as polyol can be used unless advantages of the present disclosure are impaired.

The ink may contain, in addition to titanium oxide, another pigment unless advantages of the present disclosure are impaired. In this case, the ink may be a non-white ink. The content of the other pigment (% by mass) in the ink is preferably 0.10% by mass or more to 5.00% by mass or less, more preferably 0.10% by mass or more to 1.00% by mass or less based on the total mass of the ink.

### Resin Particle

The ink contains a resin particle. The resin particle means a particle formed of a resin and is broadly divided into (i) a resin particle formed of a resin such as an acrylic resin, a urethane-based resin, an olefin-based resin or a polyester resin and (ii) a wax particle. The wax particle will be described later in detail; hereinafter, the resin particle other than the wax particle will be described. The resin particle is a component that adheres to a recording medium to form a film, to thereby increase adhesiveness between the recording medium and the image and to impart physical strength such as scratch resistance to the image. When the ink contains, as the resin particle, the wax particle, the wax particle remains on the surface of a recording medium to impart slipperiness, to improve the scratch resistance of the image. The resin particle does not necessarily contain a color material. The term “resin particle” means a resin that is present without dissolving in the aqueous medium in the ink and more specifically means a resin that can be present in the aqueous medium so as to form a particle whose particle size can be measured by dynamic light scattering. By contrast, the term “water-soluble resin” means a resin that is present while dissolving in the aqueous medium in the ink.

In this Specification, “resin is water-soluble” means the following: when the resin is neutralized with an amount of an alkali, the amount being equal to the acid value of the resin, the resin is present in the aqueous medium without forming a particle whose particle size can be measured by dynamic light scattering. Whether or not the resin is water-soluble can be determined in the following manner. First, a liquid including the resin (resin solid content: 10% by mass) neutralized with an alkali (such as sodium hydroxide or potassium hydroxide) corresponding to the acid value is prepared. Subsequently, the prepared liquid is diluted 10 fold (based on volume) with pure water to prepare a sample solution. Subsequently, when the particle size of the resin in the sample solution is measured by dynamic light scattering to find no particle having a particle size, the resin can be determined to be water-soluble. The measurement conditions in this case are as follows: for example, SetZero: 30 seconds, measurements: three times and measurement time: 180 seconds. The particle size distribution measurement apparatus employed may be, for example, a particle size analyzer using dynamic light scattering (for example, trade name “UPA-EX150”, manufactured by NIKKISO CO., LTD.). The particle size distribution measurement apparatus, measurement conditions and the like employed are obviously not limited to those described above.

Of the resin particles, the above-described (i) resin particle has an acid value of preferably 0 mgKOH/g or more to 50 mgKOH/g or less. The resin constituting the resin particle has a weight-average molecular weight of preferably 1,000 or more to 3,000,000 or less, more preferably 100,000 or more to 3,000,000 or less. The weight-average molecular weight of the resin is a polystyrene-equivalent value measured by gel permeation chromatography (GPC). Of the resin particles, the above-described (i) resin particle has a volume-based 50% cumulative particle size of preferably 50 nm or more to 500 nm or less, more preferably 100 nm or more to 300 nm or less.

In the ink, the content of the resin particle (% by mass) is preferably 0.10% by mass or more to 30.00% by mass or less, more preferably 5.00% by mass or more to 20.00% by mass or less based on the total mass of the ink. In the ink, the mass ratio of the content of the resin particle (% by mass) to the content of the titanium oxide particle (% by mass) is 0.50 times or more. The mass ratio is preferably 1.50 times or less.

As described in the formula (1), in the aqueous ink, the mass ratio of the content of the resin particle (% by mass) to the content of the titanium oxide particle (% by mass) is 0.50 times or more. In particular, the mass ratio is preferably 0.70 times or more and preferably 0.95 times or less. As described in the formula (2), in the aqueous ink, the mass ratio of the content of the water-soluble organic solvent (% by mass) to the contents of the titanium oxide particle and the resin particle (% by mass) is 0.30 times or more to 0.70 times or less. In particular, the mass ratio is preferably 0.40 times or more to 0.60 times or less.

Examples of the resin constituting the resin particle include an acrylic resin, a urethane-based resin, an olefin-based resin and a polyester resin. Of these, the acrylic resin can be employed. In other words, the resin particle can be a resin particle formed of the acrylic resin.

### Acrylic Resin

The acrylic resin can be a resin having a hydrophilic unit and a hydrophobic unit as constitutional units. Of such resins, a resin having a hydrophilic unit derived from (meth)acrylic acid and a hydrophobic unit derived from at least one of a monomer having an aromatic ring and a (meth)acrylate-based monomer can be employed. In particular, a resin having a hydrophilic unit derived from (meth)acrylic acid and a hydrophobic unit derived from at least one monomer of styrene and α-methylstyrene can be employed.

The hydrophilic unit is a unit having a hydrophilic group such as an anionic group. The hydrophilic unit can be formed by, for example, polymerizing a hydrophilic monomer having a hydrophilic group. Specific examples of the hydrophilic monomer having a hydrophilic group include acidic monomers having a carboxyl group such as (meth)acrylic acid, itaconic acid, maleic acid and fumaric acid and anionic monomers of anhydrides or salts of the acidic monomers. Examples of the cations constituting the salts of the acidic monomers include ions of lithium, sodium, potassium, ammonium and organic ammonium.

The hydrophobic unit is a unit not having a hydrophilic group such as an anionic group. The hydrophobic unit can be formed by, for example, polymerizing a hydrophobic monomer not having a hydrophilic group such as an anionic group. Specific examples of the hydrophobic monomer include monomers having an aromatic ring such as styrene, α-methylstyrene and benzyl (meth)acrylate and (meth)acrylate-based monomers such as methyl (meth)acrylate, butyl (meth)acrylate and 2-ethylhexyl (meth)acrylate.

### Urethane-Based Resin

The urethane-based resin can be obtained by, for example, causing a reaction between polyisocyanate and polyol. The reaction may be caused additionally using a chain extender. Examples of the olefin-based resin include polyethylene and polypropylene. Some of such olefin-based resins may be used as the wax particle. Examples of these include low-molecular-weight (molecular weight of several tens of thousands or less) polyethylene waxes and polypropylene waxes.

### Method for Producing Resin Particle

The resin particle can be produced by, for example, a publicly known process such as emulsion polymerization, mini-emulsion polymerization, seed polymerization or phase inversion emulsification. Of these, emulsion polymerization and seed polymerization can be employed because a resin particle having a more uniform particle size can be produced. The use of the resin particle having a more uniform particle size can further improve the ejection property of the ink in the ink jet system.

### Wax Particle

The ink can contain, as the resin particle, a particle formed of wax (wax particle). The use of the ink containing a wax particle imparts slipperiness to the surface of a recording medium, which enables recording of an image having further improved scratch resistance. The wax may be a composition containing a component other than wax or wax itself. The wax particle may be dispersed using a dispersant such as a surfactant or a water-soluble resin.

In the ink, the content of the wax particle (% by mass) is preferably 0.80% by mass or more to 5.00% by mass or less, more preferably 0.80% by mass or more to 3.00% by mass or less based on the total mass of the ink. When the content of the wax particle is less than 0.80% by mass, the amount of wax particle is excessively small and scratch resistance is insufficient in some cases. On the other hand, when the content of the wax particle is more than 5.00% by mass, the amount of wax particle is excessively large and aggregation of the resin particle is suppressed, which inferentially results in a decrease in the strength of the recorded image. As a result, scratch resistance is insufficient in some cases. In this Specification, the content of the wax particle content is defined as the total contents of the wax and the dispersant for dispersing the wax.

In the ink, the mass ratio of the content of the wax particle (% by mass) to the content of the resin particle is preferably 0.09 times or more to 0.30 times or less, more preferably 0.15 times or more to 0.25 times or less. When the mass ratio of the content of the wax particle is less than 0.09 times, the wax particle is embedded in the film of the resin particle and becomes less likely to improve scratch resistance in some cases. As a result, scratch resistance is insufficient in some cases. When the mass ratio of the content of the wax particle is more than 0.30 times, the wax particle tends to be present among the resin particles, so that the resin particles are less likely to aggregate. As a result, the image has a lower strength and insufficient scratch resistance in some cases.

The volume-based 50% cumulative particle size (D_{T} (nm)) of the titanium oxide particle, the volume-based 50% cumulative particle size (D_{E} (nm)) of the resin particle and the volume-based 50% cumulative particle size (D_{W} (nm)) of the wax particle can satisfy the relations of a formula (3) and a formula (4) below. As described in the formula (3), the volume-based 50% cumulative particle size of the wax particle can be set to the volume-based 50% cumulative particle size of the resin particle or more, so that the wax particle tends to be exposed in the surface of the image. Thus, with a small amount of the wax particle added, the property of scratch resistance can be efficiently improved. As described in the formula (4), the volume-based 50% cumulative particle size of the titanium oxide particle can be set to twice or more the volume-based 50% cumulative particle size of the resin particle, so that the resin particle can fill up the gaps among the titanium oxide particles in the surface of the recording medium, which can increase the strength of the image recorded. As a result, scratch resistance is further improved.

$${D}_{W} \geq {D}_{E} \qquad ( 3 )$$

$${D}_{T} \geq 2 \times {D}_{E} \qquad ( 4 )$$

Furthermore, the volume-based 50% cumulative particle size of the titanium oxide particle can be set to the volume-based 50% cumulative particle size of the wax particle or more. Specifically, the volume-based 50% cumulative particle size (D_{T} (nm)) of the titanium oxide particle, the volume-based 50% cumulative particle size (D_{E} (nm)) of the resin particle and the volume-based 50% cumulative particle size (D_{W} (nm)) of the wax particle can satisfy the relations of the above-described formula (4) and a formula (5) below. The wax particle can have a volume-based 50% cumulative particle size of 100 nm or more to 200 nm or less.

$${D}_{T} \geq {D}_{W} \geq {D}_{E} \qquad ( 5 )$$

Waxes in a narrow sense are esters of a water-insoluble, higher, mono- or di-hydric alcohol and a fatty acid, include animal waxes and vegetable waxes, but do not include fats and oils or fats. Waxes in a broad sense include high-melting-point fats, mineral waxes, petroleum waxes and blends and modification products of various waxes. In the present disclosure, waxes in the broad sense can be used without limitations. The waxes in the broad sense can be classified into natural waxes, synthetic waxes, blends thereof (wax blends) and modification products thereof (modified waxes).

Examples of the natural waxes include animal waxes such as beeswax, spermaceti and wool wax (lanoline); vegetable waxes such as Japan wax, carnauba wax, sugarcane wax, palm wax, candelilla wax and rice wax; mineral waxes such as montan wax; and petroleum waxes such as paraffin wax, microcrystalline wax and petrolatum. Examples of the synthetic waxes include hydrocarbon waxes such as Fischer-Tropsch wax and polyolefin wax (examples: polyethylene wax and polypropylene wax). The wax blends are mixtures of various waxes described above. The modified waxes are provided by subjecting various waxes described above to modification such as oxidation, hydrogenation, alcohol modification, acrylic modification or urethane modification. The wax is preferably at least one selected from the group consisting of microcrystalline wax, Fischer-Tropsch wax, polyolefin wax, paraffin wax and modified products and blends of the foregoing. Of these, the wax is more preferably a blend of a plurality of waxes and particularly preferably a blend of a petroleum wax and a synthetic wax.

The wax can be solid at normal temperature (25° C.). The wax has a melting point (° C.) of preferably 40° C. or more to 120° C. or less, more preferably 50° C. or more to 100° C. or less. The melting point of the wax can be measured in accordance with the test method described in 5.3.1 (melting point test method) of JIS K2235: 1991 (petroleum waxes). In the cases of microcrystalline wax, petrolatum and mixtures of a plurality of waxes, the test method described in 5.3.2 can be used to perform more accurate measurements. The melting points of waxes tend to be affected by properties such as molecular weight (the higher the molecular weight, the higher the melting point), molecular structure (linear structures provide high melting points; the presence of a branched portion results in a decrease in the melting point), crystallinity (the higher the crystallinity, the higher the melting point) and density (the higher the density, the higher the melting point). Thus, such properties can be controlled, to thereby provide waxes having desired melting points. Compound represented by general formula (1)

In the ink, the titanium oxide particle can be dispersed by the action of at least silica. The dispersion is further facilitated by polyacrylic acid that can be added to the ink. In addition to these, a component that facilitates dispersion of the titanium oxide particle may be contained. In particular, the ink can further contain a compound represented by a general formula (1) below. When the compound below is contained, ejection failure can be further suppressed, which can result in further improvement in the hiding property of the image. In the ink, the content (% by mass) of the compound represented by the general formula (1) is preferably 0.01% by mass or more to 1.00% by mass or less, more preferably 0.02% by mass or more to 0.50% by mass or less based on the total mass of the ink. In the ink, the mass ratio of the content (% by mass) of the compound represented by the general formula (1) to the content of the titanium oxide particle (% by mass) is preferably 0.002 times or more to 0.10 times or less.

In the compound represented by the general formula (1), a part of OR₁ bonded to the silicon atom hydrolyzes in an aqueous medium to form a silanol group. This provides affinity for the surface hydroxy group derived from silica in the surface of the titanium oxide particle. The compound represented by the general formula (1) includes, in addition to the above-described structure that can form a silanol group, a structure ((OR₄)ₙ in the general formula (1)) that is bonded via X serving as a linking group and has n alkylene oxide groups having 2 to 4 carbon atoms and serving as repeating units. Hereafter, the structure will also be referred to as an alkylene oxide chain. The alkylene oxide chain has hydrophilicity and hence appropriately extends in the aqueous medium to exhibit repulsive force due to steric hindrance. Thus, the compound represented by the general formula (1) has the action of facilitating dispersion of the titanium oxide particle.

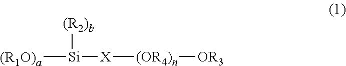

In the general formula (1), R₁, R₂ and R₃ are each independently a hydrogen atom or an alkyl group having 1 to 4 carbon atoms. R₄'s are each independently an alkylene group having 2 to 4 carbon atoms. X is a single bond or an alkylene group having 1 to 6 carbon atoms. n is 6 to 24. a is 1 to 3, b is 0 to 2 and a+b=3.

In the general formula (1), R₁, R₂ and R₃ are each independently a hydrogen atom or an alkyl group having 1 to 4 carbon atoms. Examples of the alkyl group having 1 to 4 carbon atoms include a methyl group, an ethyl group, an n-propyl group, an i-propyl group and an n-butyl group. Of these, the methyl group can be employed from the viewpoint of ease of hydrolysis. When R₁, R₂ and R₃ are each an alkyl group having more than 4 carbon atoms, formation of a silanol group by hydrolysis is difficult to achieve and the affinity for the titanium oxide particle is not provided. Thus, the titanium oxide particle is not stably dispersed and the ink has an insufficient ejection property. As a result, the image has an insufficient hiding property in some cases. a, which represents the number of R₁O's, is 1 to 3; b, which represents the number of R₂'s, is 0 to 2; a+b=3. In particular, preferably, a is 3 and b is 0; specifically, the three substituents of the silicon atom are each RIO.

In the general formula (1), R₄'s are each independently an alkylene group having 2 to 4 carbon atoms. Examples of the alkylene group having 2 to 4 carbon atoms include an ethylene group, an n-propylene group, an i-propylene group and an n-butylene group. Of these, the ethylene group can be employed. n (average value), which represents the number of OR₄'s, in other words, the number of the alkylene oxide groups, is 6 to 24. When n is less than 6, the alkylene oxide chain is excessively short and the repulsive force due to steric hindrance is not sufficiently provided; thus, the ink has an insufficient ejection property, which results in an insufficient hiding property of the image in some cases. When n is more than 24, the alkylene oxide chain is excessively long, so that it has increased hydrophilicity and tends to be loose in the aqueous medium. Thus, the affinity for the surface hydroxy group of the titanium oxide particle is insufficient and aggregation of the titanium oxide particle is less likely to be efficiently suppressed in some cases. Thus, the ink has an insufficient ejection property, which results in an insufficient hiding property of the image in some cases.

In the general formula (1), X is a single bond or an alkylene group having 1 to 6 carbon atoms. When X is a single bond, the silicon atom and OR₄ are directly bonded to each other. Examples of the alkylene group having 1 to 6 carbon atoms include a methylene group, an ethylene group, an n-propylene group, an i-propylene group, an n-butylene group, an n-pentylene group and an n-hexylene group. Of these, the n-propylene group can be employed. When X is an alkylene group having more than 6 carbon atoms, the compound represented by the general formula (1) has excessively high hydrophobicity and has a weak action of stably dispersing the titanium oxide particle, so that the ink has an insufficient ejection property in some cases. As a result, the image has an insufficient hiding property in some cases.

The compound represented by the general formula (1) can be a compound represented by a general formula (2) below. The compound represented by the general formula (2) has three OR₁'s bonded to the silicon atom, so that it can partially hydrolyze in the aqueous medium to form three hydroxy groups bonded to the silicon atom, to provide more parts having affinity for the titanium oxide particle. The compound represented by the general formula (2) has a repeating structure of ethylene oxide groups. Thus, the ethylene oxide chain appropriately extends in the aqueous medium to provide the repulsive force due to steric hindrance.

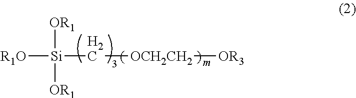

In the general formula (2), R₁ and R₃ are each independently a hydrogen atom or an alkyl group having 1 to 4 carbon atoms. m is 8 to 24.

### Polyacrylic Acid

The ink may contain polyacrylic acid. In the ink, the content of the polyacrylic acid (% by mass) is preferably 0.01% by mass or more to 0.50% by mass or less, more preferably 0.01% by mass or more to 0.20% by mass or less based on the total mass of the ink. The polyacrylic acid can facilitate dispersion of the titanium oxide particle. The polyacrylic acid is a compound having a structure as a repeating unit in which a hydrogen atom constituting a hydrocarbon chain is substituted for every other carbon atom constituting the hydrocarbon chain with a carboxylic acid group. In the polyacrylic acid, a part of the carboxyl groups undergoes electrolytic dissociation facilitated by the presence of a monovalent cation in the ink and is negatively charged. On the other hand, the surface hydroxy group derived from alumina in the titanium oxide particle is positively charged and the polyacrylic acid can adsorb to the surface of the titanium oxide particle via the surface hydroxy group derived from alumina. The titanium oxide particle to which polyacrylic acid adsorbs is negatively charged due to the surface hydroxy group derived from silica and the carboxyl group in the polyacrylic acid, so that the electrostatic repulsive force between the titanium oxide particles is increased to stably disperse the titanium oxide particles. Furthermore, even when the titanium oxide particles come close to each other during sedimentation, drying on a recording medium or the like, the presence of the polyacrylic acid can suppress coming of the titanium oxide particles close to each other with a predetermined distance or less therebetween. In other words, the polyacrylic acid has the function of a spacer. When the content of the polyacrylic acid is less than 0.01% by mass, the amount of polyacrylic acid is excessively small, the above-described advantages are not sufficiently provided and improvement in the dispersion stability is not achieved. As a result, the ejection property is also insufficient and the image has an insufficient hiding property in some cases. When the content of the polyacrylic acid is more than 0.50% by mass, an excess of polyacrylic acid other than polyacrylic acid adsorbing to the titanium oxide particle and functioning as a spacer tends to be loose in the ink. As a result, salting-out tends to occur and the titanium oxide particle aggregates, so that sufficient dispersion stability is not provided. Thus, the ejection property is also insufficient and the image has an insufficient hiding property in some cases.

The polyacrylic acid may be a commercially available product or a synthesized compound. The polyacrylic acid may be synthesized by any publicly known synthesis method. For example, the polyacrylic acid can be synthesized by polymerization of acrylic acid. The carboxyl group of the polyacrylic acid may be of an acid type or a salt type. In the case of the salt type, examples of the salt include salts of alkali metals such as lithium, sodium and potassium and salts of (organic) ammonium. The polyacrylic acid can be of the alkali metal salt type from the viewpoint of the storage stability of the ink.

The polyacrylic acid preferably has a weight-average molecular weight of 2,000 or more to 6,000 or less. When the polyacrylic acid has a weight-average molecular weight of less than 2,000, the polyacrylic acid adsorbing to the titanium oxide particle, because of the excessively small molecular size, does not function as the spacer for suppressing coming of titanium oxide particles close to each other, which does not lead to improvement in the dispersion stability. Thus, the image has an insufficient hiding property in some cases. When the polyacrylic acid has a weight-average molecular weight of more than 6,000, the polyacrylic acid has an excessively large molecular size, so that carboxyl groups may adsorb to the surfaces of a plurality of titanium oxide particles and the plurality of titanium oxide particles may be crosslinked via the polyacrylic acid. As a result, the dispersion stability is insufficient and the image has an insufficient hiding property in some cases.

The mass ratio of the content of the polyacrylic acid (% by mass) to the content of the titanium oxide particle (% by mass) is preferably 0.001 times or more. The mass ratio of the content of the polyacrylic acid (% by mass) to the content of the titanium oxide particle (% by mass) is preferably 0.010 times or less. When the mass ratio is less than 0.001 times, the amount of polyacrylic acid is excessively small relative to the titanium oxide particle and the function of facilitating dispersion of the titanium oxide particle is not sufficiently provided. As a result, the dispersion stability is insufficient and the image has an insufficient hiding property in some cases. On the other hand, when the mass ratio is more than 0.010 times, an excess of polyacrylic acid other than polyacrylic acid adsorbing to the titanium oxide particle is present and a portion of the polyacrylic acid tends to be loose in the ink. As a result, salting-out tends to occur and the titanium oxide particle is aggregated, so that the dispersion stability tends to degrade and hence the image has an insufficient hiding property in some cases.

### Other Resin

The ink may contain a resin other than the resin particle (other resin). Examples of the other resin include an acrylic resin, a urethane-based resin and a urea-based resin. Of these, the acrylic resin can be employed. In the ink, the content of the other resin (% by mass) is preferably 1.00% by mass or more to 25.00% by mass or less, more preferably 3.00% by mass or more to 15.00% by mass or less, particularly preferably 5.00% by mass or more to 15.00% by mass or less based on the total mass of the ink.

The other resin can be contained in the ink in order to improve various properties of the recorded image. Examples of the form of the other resin include a block copolymer, a random copolymer, a graft copolymer and combinations of the foregoing.

The other resin (water-soluble resin) has an acid value of preferably 80 mgKOH/g or more to 250 mgKOH/g or less, more preferably 100 mgKOH/g or more to 200 mgKOH/g or less. The other resin has a weight-average molecular weight of preferably 1,000 or more to 30,000 or less, more preferably 5,000 or more to 15,000 or less. The weight-average molecular weight of the other resin is a polystyrene-equivalent value measured by gel permeation chromatography (GPC).

Aqueous Medium

The ink is an aqueous ink containing, as an aqueous medium, water and a water-soluble organic solvent. The water can be deionized water (ion-exchanged water). In the ink, the content of the water (% by mass) is preferably 50.00% by mass or more to 95.00% by mass or less based on the total mass of the ink.

The water-soluble organic solvent is not particularly limited as long as it is water-soluble (it can be a solvent that dissolves, in a given ratio, in water at 25° C.). Specific examples include mono- or poly-hydric alcohols, alkylene glycols, glycol ethers, nitrogen-containing polar compounds and sulfur-containing polar compounds. Of these, alkanediols and alkylene glycols that are liquid at 25° C. can be employed. The shorter the carbon chain of the water-soluble resin, the faster it dries; on the other hand, the longer the carbon chain, the more advantageous it is from the viewpoint of formation of a film of the resin particle. Thus, of the alkanediols, more preferred are 1,2-alkanediols and particularly preferred are 1,2-butanediol and 1,2-pentanediol. Of the alkylene glycols, more preferred are ethylene glycol, diethylene glycol, triethylene glycol and propylene glycol and particularly preferred is propylene glycol. In other words, the water-soluble organic solvent preferably includes at least one selected from the group consisting of 1,2-butanediol, 1,2-pentanediol and propylene glycol. Use of such a water-soluble organic solvent can further improve the fixability of the image.

In the ink, the content of the water-soluble organic solvent (% by mass) is preferably 3.00% by mass or more to 50.00% by mass or less, more preferably 10.00% by mass or more to 40.00% by mass or less based on the total mass of the ink. When the content of the water-soluble organic solvent (% by mass) is less than 3.00% by mass, the ink sticks together within the ink jet recording apparatus and sticking resistance is insufficient in some cases. When the content of the water-soluble organic solvent (% by mass) is more than 50.00% by mass, a supply failure of the ink occurs in some cases. The water-soluble organic solvent is defined as not including “surfactants”.

### Other Additive

The ink may contain, in addition to the above-described additives, various additives such as a surfactant, a pH adjuster, an anticorrosive, a preservative, a fungicide, an antioxidant, a reducing inhibitor, an evaporation accelerator and a chelating agent as needed. Of these, the ink can contain the surfactant. In the ink, the content of the surfactant (% by mass) is preferably 0.10% by mass or more to 5.00% by mass or less, more preferably 0.10% by mass or more to 2.00% by mass or less based on the total mass of the ink. Examples of the surfactant include an anionic surfactant, a cationic surfactant and a nonionic surfactant. Of these, the nonionic surfactant can be employed because, from the viewpoint of adjusting various properties of the ink, the nonionic surfactant has a low affinity for the titanium oxide particle and provides the effect with a small amount thereof.

### Properties of Ink

The ink is an ink applied to the ink jet system and can be appropriately controlled in terms of properties. The ink has a surface tension at 25° C. of preferably 10 mN/m or more to 60 mN/m or less, more preferably 20 mN/m or more to 40 mN/m or less. The surface tension of the ink can be adjusted by appropriately setting the type or content of the surfactant in the ink. The ink can have a viscosity at 25° C. of 1.0 mPa·s or more to 10.0 mPa·s or less. The ink can have a pH at 25° C. of 7.0 or more to 9.0 or less. The pH of the ink can be measured using an ordinary pH meter including a glass electrode and the like.

### Ink Cartridge

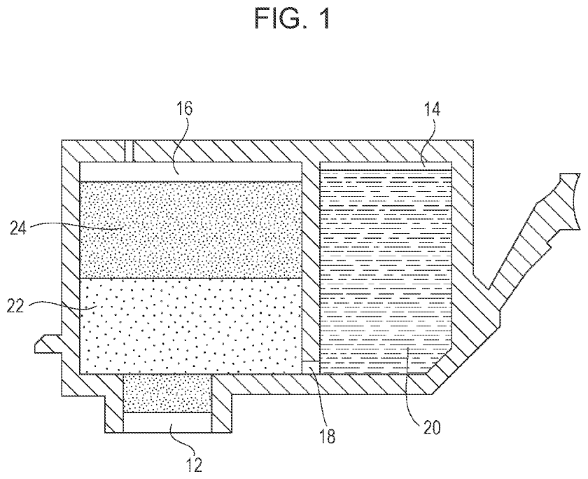

An ink cartridge according to an embodiment of the present disclosure includes an ink and an ink storage portion containing the ink. The ink contained in the ink storage portion is the above-described aqueous ink (white ink) according to an embodiment of the present disclosure. FIG. 1 is a sectional view schematically illustrating an ink cartridge according to an embodiment of the present disclosure. As illustrated in FIG. 1, in the bottom surface of the ink cartridge, an ink supply port 12 for supplying the ink to the recording head is disposed. The interior of the ink cartridge is an ink storage portion for containing the ink. The ink storage portion is constituted by an ink containing chamber 14 and an absorber containing chamber 16, which are in communication with each other via a communication port 18. The absorber containing chamber 16 and the ink supply port 12 communicate. The ink containing chamber 14 contains a liquid ink 20. The absorber containing chamber 16 contains absorbers 22 and 24 impregnated with the ink to keep the ink. Alternatively, the ink storage portion does not have the ink containing chamber containing a liquid ink and may keep the entire ink using an absorber. Alternatively, the ink storage portion does not have an absorber and may contain the entire ink in a liquid form. Alternatively, an ink cartridge may be provided so as to include an ink storage portion and a recording head.

### Ink Jet Recording Method

An ink jet recording method according to an embodiment of the present disclosure is a method including ejecting the above-described aqueous ink according to an embodiment of the present disclosure through an ink jet recording head to record an image on a recording medium. The ink ejection system is, for example, a system of applying mechanical energy to the ink or a system of applying thermal energy to the ink. In an embodiment of the present disclosure, the system of applying thermal energy to the ink to eject the ink can be employed. Other than the use of the ink according to an embodiment of the present disclosure, the steps of the ink jet recording method may be publicly known steps. For example, in the case of using a white ink to record an image, the method can be directly applied to an ordinary ink jet recording method. Alternatively, in the case of using a white ink in a background color treatment for color inks, color inks (such as black, cyan, magenta and yellow inks) can be applied so as to at least partially overlap the region where the white ink has been applied, to form an image.

The ink jet recording method can also be applied to back printing in which a white ink is applied so as to at least partially overlap a region where a color ink has been applied. The recording medium is not particularly limited and can be a transparent or color recording medium because an aqueous ink according to an embodiment of the present disclosure can be used as a white ink. Alternatively, the recording medium may be a slightly absorbent medium (unabsorbent medium) having low absorbency for a liquid medium such as a resin film.

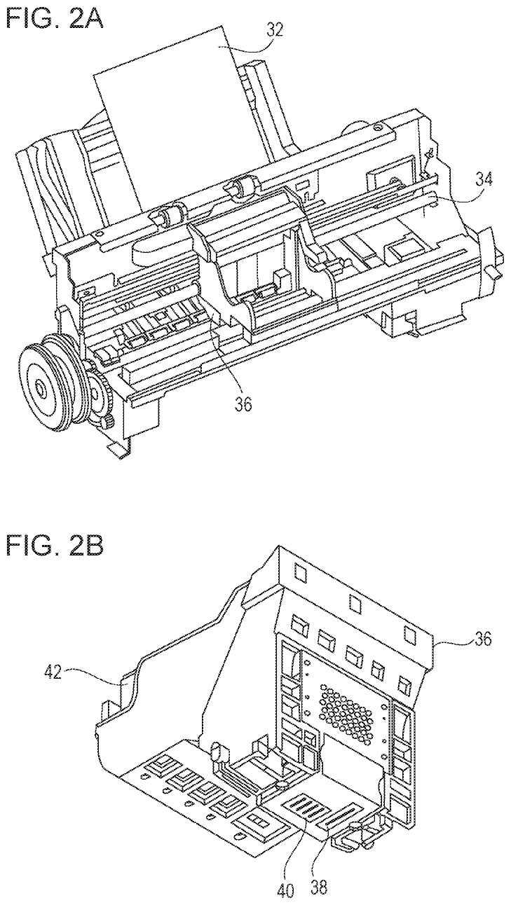

FIG. 2A is a perspective view schematically illustrating a main part of an ink jet recording apparatus used for an ink jet recording method according to an embodiment of the present disclosure and FIG. 2B is a perspective view schematically illustrating a head cartridge of the ink jet recording apparatus. The ink jet recording apparatus includes a conveying unit (not shown) for conveying a recording medium 32 and a carriage shaft 34. A head cartridge 36 can be mounted on the carriage shaft 34. The head cartridge 36 includes recording heads 38 and 40 and is configured to receive an ink cartridge 42. While the head cartridge 36 is conveyed along the carriage shaft 34 in the main scanning direction, the ink (not shown) is ejected through the recording heads 38 and 40 to the recording medium 32. The recording medium 32 is conveyed by the conveying unit (not shown) in the sub-scanning direction, so that an image is recorded on the recording medium 32.

The ink can be applied to unit areas of a recording medium by multipass recording of individually performing a plurality of relative scans of the recording head and the recording medium. In particular, application of the white ink and application of a color ink to unit areas can be individually performed by different relative scans. This increases the time elapsed until the inks come into contact with each other, which tends to suppress mixing. Such a unit area can be defined as a desired area such as a single pixel or a single band.

From the viewpoint of efficient application to an unabsorbent medium, an ink jet recording method according to an embodiment of the present disclosure can further include a reactive liquid application step of applying an aqueous reactive liquid containing a reactive agent that reacts with the aqueous ink, to the recording medium. Hereafter, the aqueous reactive liquid may be simply referred to as the reactive liquid.

### Reactive Liquid

The reactive liquid reacts with the ink upon contact with the ink to aggregate components in the ink (components having an anionic group such as a resin and a self-dispersible pigment) and contains a reactive agent. Examples of the reactive agent include cationic components such as a polyvalent metal ion and a cationic resin and an organic acid.

Examples of the polyvalent metal ion include divalent metal ions such as Ca²⁺, Cu²⁺, Ni²⁺, Mg²⁺, Sr²⁺, Ba²⁺ and Zn²⁺ and trivalent metal ions such as Fe³⁺, Cr³⁺, Y³⁺ and Al³⁺. In order to provide a reactive liquid containing a polyvalent metal ion, a polyvalent metal salt (may be hydrate) in which a polyvalent metal ion and an anion are bonded together can be used. Examples of the anion include inorganic anions such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄²⁻ and H₂PO₄⁻; organic anions such as HCOO⁻, (COO⁻)₂, COOH(COO⁻), CH₃COO⁻, C₂H₅COO⁻, CH₃CH(OH)COO⁻, C₂H₄ (COO⁻)₂, C₆H₅COO⁻, C₆H₄ (COO⁻)₂ and CH₃SO₃⁻. In the case of using, as the reactive agent, a polyvalent metal ion, the content of the polyvalent metal ion (% by mass) in terms of a polyvalent metal salt in the reactive liquid is preferably 1.00% by mass or more to 20.00% by mass or less based on the total mass of the reactive liquid.

The reactive liquid containing an organic acid has a buffer action in the acidic region (having a pH of less than 7.0, preferably a pH of 2.0 to 5.0), to thereby turn efficiently an anionic group of a component in the ink to its acid type to cause aggregation. Examples of the organic acid include monocarboxylic acids and salts thereof such as formic acid, acetic acid, propionic acid, butyric acid, benzoic acid, glycolic acid, lactic acid, salicylic acid, pyrrolecarboxylic acid, furancarboxylic acid, picolinic acid, nicotinic acid, thiophenecarboxylic acid, levulinic acid and coumarinic acid; dicarboxylic acids and salts and hydrogen salts thereof such as oxalic acid, malonic acid, succinic acid, glutaric acid, adipic acid, maleic acid, fumaric acid, itaconic acid, sebacic acid, phthalic acid, malic acid and tartaric acid; tricarboxylic acids and salts and hydrogen salts thereof such as citric acid and trimellitic acid; tetracarboxylic acids and salts and hydrogen salts thereof such as pyromellitic acid. In the case of using, as the reactive agent, an organic acid, the content of the organic acid (% by mass) in the reactive liquid is preferably 1.00% by mass or more to 50.00% by mass or less based on the total mass of the reactive liquid.

Examples of the cationic resin include a resin having a structure of a primary to tertiary amine and a resin having a structure of a quaternary ammonium salt. Specific examples include resins having a structure of vinylamine, allylamine, vinylimidazole, vinylpyridine, dimethylaminoethyl methacrylate, ethyleneimine, guanidine, diallyldimethylammonium chloride or an alkylamine-epichlorohydrin condensate. In order to increase the solubility in the reactive liquid, the cationic resin may be used in combination with an acidic compound or the cationic resin may be subjected to a quaternary treatment. In the case of using, as the reactive agent, a cationic resin, the content of the cationic resin (% by mass) in the reactive liquid is preferably 0.10% by mass or more to 10.00% by mass or less based on the total mass of the reactive liquid.

### EXAMPLES

Hereinafter, the present disclosure will be described further in detail with reference to Examples and Comparative Examples; however, the present disclosure within the spirit and scope thereof is not limited by the following Examples at all. The amounts of components described in “parts” and “%” are based on mass unless otherwise specified. Dispersion liquids of titanium oxide particles will be described as “pigment dispersion liquids”.

### Preparation of Reactive Liquid

The following components were mixed together to prepare a reactive liquid.
Magnesium sulfate heptahydrate: 2.0 parts
Poly(diallyldimethylammonium chloride) (trade name “UNISENCE FPA101L”, manufactured by SENKA corporation, cationic resin content: 35.0%): 7.1 parts
1,2-Butanediol: 20.0 parts
Fluorine-based nonionic surfactant (trade name “Capstone FS3100”, manufactured by LEHVOSS Group): 0.5 parts
Preservative (trade name “PROXEL GXL(S)”, manufactured by Arch Chemicals, Inc.): 0.2 parts
Ion-exchanged water: 70.2 parts

### Preparation of Titanium Oxide

Commercially available, surface-treated titanium oxide particles and titanium oxide particles prepared by surface-treating untreated titanium oxides were used. The volume-based 50% cumulative particle sizes (D₅₀) of the titanium oxide particles were measured using a particle size analyzer using dynamic light scattering (trade name “Nanotrac Wave II-EX150”, manufactured by MicrotracBEL Corp.). Properties of the titanium oxide particles will be described in Table 1. In Table 1, TITANIX: JR, JR-403 and JR-405 are trade names of rutile titanium oxides manufactured by Tayca Corporation. Measurement of coverage amounts of alumina and silica

The contents of alumina and silica in such a titanium oxide particle, namely, coverage amounts of alumina and silica were measured in the following manner. The prepared titanium oxide particle was added to nitric acid to provide a liquid serving as a sample. The sample was subjected to quantitative analysis of the aluminum and silicon elements using an inductively coupled plasma (ICP) emission spectroscope. In the analysis, atoms covering the surface were all assumed to be oxides and the measured values of aluminum and silicon were converted into values in terms of the oxides, specifically, alumina and silica to calculate the mass ratio.

### Titanium Oxide Particle 1

A titanium oxide was surface-treated by a wet process to produce a titanium oxide particle 1. The surface treatment performed by the wet process was bringing surface treatment agents (such as sodium aluminate and sodium silicate) into contact with an untreated titanium oxide; the amounts and ratio of the surface treatment agents were appropriately adjusted to thereby perform the surface treatment in the given ratio.

Specifically, 300 parts of a rutile titanium oxide not having been subjected to surface treatment (trade name “TITANIX JR”, manufactured by Tayca Corporation) and 700 parts of pure water were mixed together using a homogenizer. Under stirring, the mixture was heated to 90° C. and potassium hydroxide (pH adjuster) was added so as to adjust the pH to 10.5. Subsequently, sodium silicate was added and dilute sulfuric acid (pH adjuster) was added over about 1 hour to thereby adjust the pH to 5.0. The reaction was caused continuously for about 1 hour. Subsequently, at 90° C., sodium aluminate was added in small portions. At this time, in order to keep the pH, dilute sulfuric acid was also used to keep the pH to 6.0 or more to 8.0 or less. After the addition of sodium aluminate, the reaction was caused continuously for about 1 hour, to provide a dispersion liquid. After the dispersion liquid was cooled to 25° C., sedimentation using a centrifuge and re-dispersion in ion-exchanged water were repeated to thereby perform purification; and the product was dried at 120° C. to thereby provide a titanium oxide particle 1 surface-treated with alumina and silica. Table 1 describes properties of the titanium oxide particle 1. Titanium oxide particles 2, 4 and 5

Commercially available titanium oxide particles (including titanium oxide particles having been surface-treated with alumina or silica) were used as titanium oxide particles 2, 4 and 5. Table 1 also describes properties of the titanium oxide particles 2, 4 and 5. TITANIX: JR-403 and JR-405 are trade names of rutile titanium oxides manufactured by Tayca Corporation. TIPAQUE CR-80 is the trade name of a rutile titanium oxide manufactured by ISHIHARA SANGYO KAISHA, LTD. Some commercially available titanium oxide particles contained, in addition to alumina and silica, an inorganic oxide such as zirconia or zinc oxide or an organic compound such as polyol; the content of such a component was at the maximum about 1.00%. Thus, for convenience, the contents of such components are collectively shown by describing the content T (%) of titanium oxide in the titanium oxide particle (“Titanium oxide T (%)” in Table 1).

### Titanium Oxide Particle 3

The same procedures as in the method for preparing the titanium oxide particle 1 were performed except that a commercially available rutile titanium oxide surface-treated with alumina (trade name “TITANIX JR-405”, manufactured by Tayca Corporation) was used, to provide a titanium oxide particle 3 surface-treated with alumina and silica.

TABLE 1
Properties of titanium oxide particles

| | | Content in titanium oxide particle (%) | | | | | | | |
|---|---|---|---|---|---|---|---|---|---|
| Titanium | | Titanium | Aluminum | | Silicon | | Value | Value | |
| oxide | | oxide | element | Alumina | element | Silica | of a/s | of A/S | D₅₀ |
| particle | Type | T(%) | a(%) | A(%) | s(%) | S(%) | (times) | (times) | (nm) |
| 1 | Particle provided by surface-treating | 94.90 | 1.06 | 2.00 | 1.45 | 3.10 | 0.73 | 0.65 | 290 |
| | trade name “TITANIX JR” | | | | | | | | |
| 2 | Trade name “TITANIX JR-403” | 95.70 | 1.06 | 2.00 | 1.07 | 2.30 | 0.98 | 0.87 | 250 |
| 3 | Particle provided by surface-treating | 98.08 | 0.45 | 0.85 | 0.50 | 1.07 | 0.90 | 0.79 | 230 |
| | trade name “TITANIX JR-405” | | | | | | | | |
| 4 | Trade name “TITANIX JR-405” | 99.10 | 0.48 | 0.90 | 0.00 | 0.00 | — | — | 210 |
| 5 | Trade name “TIPAQUE CR-80” | 95.55 | 1.39 | 2.62 | 0.86 | 1.83 | 1.62 | 1.43 | 250 |

### Preparation of Compound Represented by General Formula (1)

The compound represented by the general formula (1) was synthesized in the following manner. Compounds synthesized as the compound represented by the general formula (1) and comparative compounds will be described in terms of synthesis conditions and structures in Table 2 and Table 3. The compound represented by the general formula (1) can be synthesized by subjecting a raw material (such as polyalkylene glycol monoalkyl ether) to allylation and hydrosilylation.

Into a three-necked flask equipped with a stirring bar and a nitrogen inlet, a raw material, a base and a solvent (tetrahydrofuran, also referred to as THF) described in Table 2 were placed and stirred at 25° C. for 30 minutes. As “sodium hydride”, a paraffin dispersion liquid of 60% sodium hydride was used and the dispersion liquid was used such that the amount of sodium hydride used in Table 2 was satisfied. Subsequently, while the bromide in Table 2 was added dropwise, the reaction solution was stirred at 25° C.; after completion of the dropwise addition, stirring was continued for 12 hours to provide a solution containing a reaction product. From the solution containing the reaction product, unreacted sodium hydride and the neutralization product (sodium bromide) were filtered off; subsequently, the pressure was reduced to remove THE, to provide a concentrate. The concentrate was dissolved in 500 parts of pure water; this aqueous solution was extracted with 200 mL of hexane three times and subsequently extracted with 200 mL of dichloromethane. The solvent containing the product was dried by addition of magnesium sulfate and concentrated under a reduced pressure to provide an allylated compound (allylation step).

Into a passivated, dry round bottom flask equipped with a stirring bar and an argon inlet, an allylated raw material and a silane compound in Table 2 were placed and stirred at 85° C. Subsequently, 0.54 parts of an isopropyl alcohol aqueous solution of 65 mmol/L chloroplatinic acid monohydrate was added and heated at 85° C. for 5 hours. After completion of the reaction, the mixture was left to cool to 25° C. and subjected to a reduced pressure to remove an excess of the silane compound. The residue was purified by column chromatography using, as the carrier, silica gel passivated with triethoxysilane; in this way, compounds were provided (hydrosilylation step). In the purification performed by column chromatography, ethyl acetate/hexane/ethanol=85/15/5 (based on volume) was used as the eluent.

TABLE 2
Synthesis conditions for compound represented by general formula (1)

| | | | | | | | | | Hydrosilylation step | | |
|---|---|---|---|---|---|---|---|---|---|---|---|
| | | | | | | | | | Allylated | | |
| | Allylation step | | | | | | | | raw | | |
| | Raw material | | Base | | Solvent | | Bromide | | material | Silane compound | |
| | | Amount | | Amount | | Amount | | Amount | Amount | | Amount |
| Compound | Type | (parts) | Type | (parts) | Type | (parts) | Type | (parts) | (parts) | Type | (parts) |
| 1 | Polyethylene | 28.3 | Sodium | 2.9 | THF | 200 | Allyl | 8.7 | 6.1 | Trimethoxysilane | 18.4 |
| | glycol | | hydride | | | | bromide | | | | |
| | monomethyl | | | | | | | | | | |
| | ether (n = 10) | | | | | | | | | | |
| 2 | Polyethylene | 17.8 | Sodium | 2.9 | THF | 200 | Allyl | 8.7 | 4.0 | Trimethoxysilane | 18.4 |
| | glycol | | hydride | | | | bromide | | | | |
| | monomethyl | | | | | | | | | | |
| | ether (n = 6) | | | | | | | | | | |
| 3 | Polyethylene | 49.5 | Sodium | 2.9 | THF | 200 | Allyl | 8.7 | 13.5 | Trimethoxysilane | 18.4 |
| | glycol | | hydride | | | | bromide | | | | |
| | monomethyl | | | | | | | | | | |
| | ether (n = 24) | | | | | | | | | | |

TABLE 3
Structures of synthesized compounds represented by general formula (1)

| Compound | X | R₁ | R₂ | R₃ | R₄ | n | a | b | Name of compound |
|---|---|---|---|---|---|---|---|---|---|
| 1 | n-Propylene | Methyl | — | Methyl | Ethylene | 10 | 3 | 0 | 3-(Methoxy(oxyethylene 10)) |
| | group | group | | group | group | | | | propyltrimethoxysilane |
| 2 | n-Propylene | Methyl | — | Methyl | Ethylene | 6 | 3 | 0 | 3-(Methoxy(oxyethylene 6)) |
| | group | group | | group | group | | | | propyltrimethoxysilane |
| 3 | n-Propylene | Methyl | — | Methyl | Ethylene | 24 | 3 | 0 | 3-(Methoxy(oxyethylene 24)) |
| | group | group | | group | group | | | | propyltrimethoxysilane |

### Preparation of Pigment Dispersion Liquids

Pigment dispersion liquids were produced in the following manner. The production conditions of the pigment dispersion liquids will be described in Table 4.

### Pigment Dispersion Liquids 1 to 10

A titanium oxide particle (40.00 parts), a dispersant in Table 4, potassium hydroxide and ion-exchanged water (the amount was determined such that the total of the components became 100.00 parts) were mixed together and subjected to preliminary dispersion treatment using a homogenizer. The amount of potassium hydroxide used was appropriately adjusted such that pH in another dispersion treatment subsequently performed would be 10.5. The pH in this dispersion treatment is the value measured, at the start of the dispersion treatment, using a pH meter (trade name “Portable pH meter D-74”, manufactured by HORIBA, Ltd.). Subsequently, 0.5 mm zirconia beads were used at 25° C. in a paint shaker to perform the dispersion treatment for 12 hours. The zirconia beads were filtered off and, as needed, an appropriate amount of ion-exchanged water was added; in this way, pigment dispersion liquids having a titanium oxide particle content of 40.00% were prepared. In Table 4, for the pigment dispersion liquids 5 and 9, “Aqueous solution of water-soluble resin” was synthesized by a method described later and had a resin content of 40.00%. For the pigment dispersion liquid 10, “Polyacrylic acid” is a polyacrylic acid having a weight-average molecular weight of 5000 (trade name “polyacrylic acid 5,000” manufactured by FUJIFILM Wako Pure Chemical Corporation).

TABLE 4
Production conditions of pigment dispersion liquids

| | | |
|---|---|---|
| Pigment | Titanium | Dispersant |

| dispersion | oxide | | Amount |
|---|---|---|---|
| liquid | particle | Compound | (parts) |
| 1 | 1 | 1 | 1.20 |
| 2 | 2 | 1 | 1.20 |
| 3 | 2 | 2 | 1.20 |
| 4 | 2 | 3 | 1.20 |
| 5 | 2 | Aqueous solution of | 13.25 |
| | | water-soluble resin | |
| 6 | 3 | 1 | 1.20 |
| 7 | 2 | — | |
| 8 | 4 | 1 | 1.20 |
| 9 | 1 | Aqueous solution of | 13.25 |
| | | water-soluble resin | |
| 10 | 5 | Polyacrylic acid | 6.00 |

### Synthesis of Resin Particles

Into a four-necked flask equipped with a stirrer, a reflux condenser and a nitrogen gas inlet, 0.2 parts of potassium persulfate and 74.0 parts of ion-exchanged water were placed and nitrogen gas was introduced. The monomers in Table 5 and 0.3 parts of an emulsifier (trade name “NIKKOL BC15”, manufactured by Nikko Chemicals Co., Ltd.) were mixed together, to provide a mixture. The mixture was added dropwise to the four-necked flask under stirring over 1 hour and subsequently a reaction was caused at a temperature of 80° C. for 2 hours. Subsequently, the content was cooled to 25° C. and then potassium hydroxide in an amount of moles equal to the acid value of the resin and an appropriate amount of ion-exchanged water were added; in this way, aqueous dispersion liquids of resin particles having a resin particle content of 40.00% were prepared. For the resin particles, acid values and particle sizes (volume-based 50% cumulative particle sizes) will be described in Table 5. Components in Table 5 are specifically as follows.
BMA: butyl methacrylate
MAA: methacrylic acid

TABLE 5
Synthesis conditions and properties of resin particles

| | | | |
|---|---|---|---|
| Resin | Monomer (parts) | Acid value | Particle size |

| particle | BMA | MAA | (mgKOH/g) | (nm) |
|---|---|---|---|---|
| 1 | 97.8 | 2.2 | 14.3 | 120 |
| 2 | 96.5 | 3.5 | 23.4 | 140 |
| 3 | 95.6 | 4.4 | 28.7 | 100 |

In addition, an aqueous dispersion liquid of a resin particle 4 was prepared: a commercially available, self-emulsifiable, anion-type, polyether-type, polyurethane emulsion aqueous dispersion liquid (trade name “TAKELAC W-5025”, manufactured by Mitsui Chemicals, Inc., urethane resin particle content: 30.0%, volume-based 50% cumulative particle size: 20.3 nm).

### Synthesis of Water-Soluble Resin

Butyl methacrylate (81.6 parts) and 18.4 parts of methacrylic acid were polymerized by standard procedures to synthesize a water-soluble acrylic resin. Ion-exchanged water containing potassium hydroxide in an amount of moles equal to the acid value was added to neutralize the acid group and subsequently an appropriate amount of water was further added, to provide an aqueous solution of the water-soluble resin having a resin content of 40.00%. This water-soluble resin had an acid value of 120.0 mgKOH/g.

### Preparation of Aqueous Dispersion Liquids of Wax Particle

### Aqueous Dispersion Liquid of Wax Particle 1

A wax (25.0 parts), 5.0 parts of a nonionic surfactant, 1.0 part of a phosphate (butoxyethylated), 1.0 part of oleic acid and 1.0 part of triethanolamine were added to 67.0 parts of ion-exchanged water. The wax employed was a Fischer-Tropsch wax (trade name “FT-0165”, melting point: 73° C., manufactured by NIPPON SEIRO CO., LTD.). The nonionic surfactant employed was polyoxyethylene cetyl ether (trade name “NIKKOL BC-15”, manufactured by Nikko Chemicals Co., Ltd.). The mixture was heated to 100° C. and subjected to, using a homogenizer equipped with a heating circulation line, a first circulation emulsification under a pressure condition of 10 Mpa. When the volume-average particle size (D₅₀) decreased to about 500 nm, the pressure was further increased to 25 MPa and a second circulation emulsification was continuously performed to perform the dispersion treatment until the volume-average particle size (D₅₀) reached 180 nm. Continuously, the mixture was subjected to pressure filtration using a cellulose acetate filter having a pore size of 3.0 μm (manufactured by Advantec) and diluted with ion-exchanged water, to provide an aqueous dispersion liquid of a wax particle 1 having a wax particle content of 40.00%.

The volume-average particle size (volume-based 50% cumulative particle size D₅₀) is the diameter of a particle corresponding to 50% in the particle-size cumulative curve drawn from the smaller particle size side on the basis of the total of the measured volumes of particles. The volume-average particle size was measured using the above-described particle size analyzer using dynamic light scattering and measurement conditions.

### Aqueous Dispersion Liquid of Wax Particle 2

The same procedures as in the preparation of the aqueous dispersion liquid of the wax particle 1 were performed except that, in the second circulation emulsification, the dispersion treatment was performed until the volume-average particle size (D₅₀) reached 130 nm, to provide an aqueous dispersion liquid of a wax particle 2 having a wax particle content of 40.00%.

### Aqueous Dispersion Liquid of Wax Particle 3

The same procedures as in the preparation of the aqueous dispersion liquid of the wax particle 1 were performed except that the wax was replaced by a paraffin wax (trade name “Parraffin Wax-155”, melting point: 69° C., manufactured by NIPPON SEIRO CO., LTD.), to provide an aqueous dispersion liquid of a wax particle 3 having a wax particle content of 40.0%.

### Aqueous Dispersion Liquid of Wax Particle 4

The same procedures as in the preparation of the aqueous dispersion liquid of the wax particle 1 were performed except that the wax was replaced by a polyethylene wax (trade name “SANWAX 171-P”, melting point: 100° C., manufactured by NIPPON SEIRO CO., LTD.), to provide an aqueous dispersion liquid of a wax particle 4 having a wax particle content of 40.0%.

### Preparation of Inks

Components whose types and amounts are described in upper portions of Table 6 to Table 9 were mixed together and stirred. Acetylenol E60 (trade name) is a nonionic surfactant manufactured by Kawaken Fine Chemicals Co., Ltd. For each of polyacrylic acids, its weight-average molecular weight and the type of the salt are collectively described. For example, in the case of “Polyacrylic acid (Mw1,900, Na salt)”, the weight-average molecular weight is 1,900 and the polyacrylic acid is of a sodium salt type. Subsequently, pressure filtration using a membrane filter having a pore size of 5.0 μm (manufactured by Sartorius AG) was performed, to prepare inks.

In the cases of inks each prepared from a pigment dispersion liquid using a titanium oxide particle in which at least a portion Of the surface is covered with at least silica, the cells for “Silica contributes to dispersion of titanium oxide particle?” are filled with “Yes”. However, when inks contain 0.01% by mass or more of a water-soluble resin other than polyacrylic acid, it tends to destabilize dispersion due to the action of silica. In such cases, the cells for “Silica contributes to dispersion of titanium oxide particle?” are filled with “No”. The term “resin particle” includes the wax particle; however, for convenience, the total content of the wax particle is described in “Wax particle content W (%)” in Table 6 to Table 9 and the total content of the resin particle except for the wax particle is described in “Resin particle content E (%)” in Table 6 to Table 9.

TABLE 6
Composition and properties of inks

| | Example | | | | | | | | | | |
|---|---|---|---|---|---|---|---|---|---|---|---|
| | 1 | 2 | 3 | 4 | 5 | 6 | 7 | 8 | 9 | 10 | 11 |
| Type of pigment dispersion liquid | 1 | 2 | 2 | 3 | 4 | 2 | 2 | 2 | 2 | 2 | 2 |
| Pigment dispersion liquid | 37.50 | 37.50 | 41.80 | 37.50 | 37.50 | 37.50 | 37.50 | 38.00 | 41.80 | 37.50 | 37.50 |
| Aqueous dispersion liquid of resin | 22.50 | | 25.00 | 22.50 | 22.50 | 22.50 | 22.50 | | 25.00 | | |
| particle 1 | | | | | | | | | | | |
| Aqueous dispersion liquid of resin | | | | | | | | 16.00 | | 18.00 | |
| particle 2 | | | | | | | | | | | |
| Aqueous dispersion liquid of resin | | 22.50 | | | | | | | | | 22.50 |
| particle 3 | | | | | | | | | | | |
| Aqueous dispersion liquid of resin | | | | | | | | | | | |
| particle 4 | | | | | | | | | | | |
| Aqueous dispersion liquid of wax | 7.50 | 5.00 | 5.56 | 7.50 | 7.50 | | | 3.00 | 5.56 | 7.50 | 5.00 |
| particle 1 | | | | | | | | | | | |
| Aqueous dispersion liquid of wax | | | | | | | | | | | |
| particle 2 | | | | | | | | | | | |
| Aqueous dispersion liquid of wax | | | | | | 7.50 | | | | | |
| particle 3 | | | | | | | | | | | |
| Aqueous dispersion liquid of wax | | | | | | | 7.50 | | | | |
| particle 4 | | | | | | | | | | | |
| Polyacrylic acid (Mw 1,900, Na salt) | | | | | | | | | | | |
| Polyacrylic acid (Mw 2,000, Na salt) | | | | | | | | | | | |
| Polyacrylic acid (Mw 2,500, Na salt) | 0.05 | 0.05 | 0.06 | 0.05 | 0.05 | 0.05 | 0.05 | 0.05 | 0.06 | 0.06 | 0.05 |
| Polyacrylic acid (Mw 6,000, Na salt) | | | | | | | | | | | |
| Polyacrylic acid (Mw 6,100, Na salt) | | | | | | | | | | | |
| 1,2-Butanediol | 15.00 | 15.00 | 16.67 | 15.00 | 15.00 | 15.00 | 15.00 | 15.00 | 19.17 | 7.50 | |
| 1,2-Pentanediol | | | | | | | | | | | 10.00 |
| 1,2-Hexanediol | | | | | | | | | 1.00 | | |
| 2-Methyl-1,3-propanediol | | | | | | | | | | | |
| Ethylene glycol | | | | | | | | | | | |
| Diethylene glycol | | | | | | | | | | | |
| Triethylene glycol | | | | | | | | | | | |
| Propylene glycol | | | | | | | | | | | |
| 2-Pyrrolidone | | | | | | | | | | | |
| Glycerol | | | | | | | | | | | |
| Acetylenol E60 | 0.50 | 0.50 | 0.56 | 0.50 | 0.50 | 0.50 | 0.50 | 0.50 | 0.56 | 0.62 | 0.50 |
| Ion-exchanged water | 16.95 | 19.45 | 10.35 | 16.95 | 16.95 | 16.95 | 16.95 | 27.45 | 6.85 | 28.82 | 24.45 |
| Titanium oxide particle content T(%) | 15.00 | 15.00 | 16.72 | 15.00 | 15.00 | 15.00 | 15.00 | 15.20 | 16.72 | 15.00 | 15.00 |
| Wax particle content W(%) | 3.00 | 2.00 | 2.22 | 3.00 | 3.00 | 3.00 | 3.00 | 1.20 | 2.22 | 3.00 | 2.00 |
| Resin particle content E(%) | 9.00 | 9.00 | 10.00 | 9.00 | 9.00 | 9.00 | 9.00 | 6.40 | 10.00 | 7.20 | 9.00 |
| Polyacrylic acid content A(%) | 0.05 | 0.05 | 0.06 | 0.05 | 0.05 | 0.05 | 0.05 | 0.05 | 0.06 | 0.06 | 0.05 |
| Water-soluble organic solvent content | 15.00 | 15.00 | 16.67 | 15.00 | 15.00 | 15.00 | 15.00 | 15.00 | 20.17 | 7.50 | 10.00 |
| S(%) | | | | | | | | | | | |
| Value of (E + W)/T (times) | 0.80 | 0.73 | 0.73 | 0.80 | 0.80 | 0.80 | 0.80 | 0.50 | 0.73 | 0.68 | 0.73 |
| Value of A/T (times) | 0.003 | 0.003 | 0.004 | 0.003 | 0.003 | 10.003 | 0.003 | 0.003 | 0.004 | 0.004 | 0.003 |
| Value of S/(T + E + W) (times) | 0.56 | 0.58 | 0.58 | 0.56 | 0.56 | 0.56 | 0.56 | 0.66 | 0.70 | 0.30 | 0.38 |
| Value of W/(E + W) (times) | 0.25 | 0.18 | 0.18 | 0.25 | 0.25 | 0.25 | 0.25 | 0.16 | 0.18 | 0.29 | 0.18 |
| Silica contributes to dispersion of | Yes | Yes | Yes | Yes | Yes | Yes | Yes | Yes | Yes | Yes | Yes |
| titanium oxide particle? | | | | | | | | | | | |

TABLE 7
Composition and properties of inks

| | Example | | | | | | | | | | |
|---|---|---|---|---|---|---|---|---|---|---|---|
| | 12 | 13 | 14 | 15 | 16 | 17 | 18 | 19 | 20 | 21 | 22 |
| Type of pigment dispersion liquid | 2 | 2 | 2 | 2 | 2 | 2 | 5 | 1 | 2 | 2 | 1 |
| Pigment dispersion liquid | 37.50 | 37.50 | 37.50 | 37.50 | 37.50 | 37.50 | 37.50 | 30.00 | 35.00 | 37.50 | 37.50 |
| Aqueous dispersion liquid of resin | | | | | | | 22.50 | | 25.00 | 25.00 | |
| particle 1 | | | | | | | | | | | |
| Aqueous dispersion liquid of resin | | | | | | | | | | | |
| particle 2 | | | | | | | | | | | |
| Aqueous dispersion liquid of resin | 22.50 | 22.50 | 22.50 | 22.50 | 22.50 | 22.50 | | | | | 20.00 |
| particle 3 | | | | | | | | | | | |
| Aqueous dispersion liquid of resin | | | | | | | | 20.00 | | | |
| particle 4 | | | | | | | | | | | |
| Aqueous dispersion liquid of wax | 5.00 | 5.00 | 5.00 | 5.00 | 5.00 | 5.00 | 2.50 | 5.00 | 2.00 | 2.50 | 8.50 |
| particle 1 | | | | | | | | | | | |
| Aqueous dispersion liquid of wax | | | | | | | | | | | |
| particle 2 | | | | | | | | | | | |
| Aqueous dispersion liquid of wax | | | | | | | | | | | |
| particle 3 | | | | | | | | | | | |
| Aqueous dispersion liquid of wax | | | | | | | | | | | |
| particle 4 | | | | | | | | | | | |
| Polyacrylic acid (Mw 1,900, Na salt) | | | | | | | | | | | |
| Polyacrylic acid (Mw 2,000, Na salt) | | | | | | | | | | | |
| Polyacrylic acid (Mw 2,500, Na salt) | 0.05 | 0.05 | 0.05 | 0.05 | 0.05 | 0.05 | 0.05 | 0.04 | 0.05 | 0.05 | 0.06 |
| Polyacrylic acid (Mw 6,000, Na salt) | | | | | | | | | | | |
| Polyacrylic acid (Mw 6,100, Na salt) | | | | | | | | | | | |
| 1,2-Butanediol | | | | | 10.00 | | 15.00 | 10.00 | 15.00 | 15.00 | 15.00 |
| 1,2-Pentanediol | | | | | | | | | | | |
| 1,2-Hexanediol | 10.00 | | | | | | | 1.00 | | | |
| 2-Methyl-1,3-propanediol | | 10.00 | | | | | | | | | |
| Ethylene glycol | | | 15.00 | | | | | | | | |
| Diethylene glycol | | | | 15.00 | | | | | | | |
| Triethylene glycol | | | | | 2.00 | | | | | | |
| Propylene glycol | | | | | | 15.00 | | | | | |
| 2-Pyrrolidone | | | | | | | | | | | |
| Glycerol | | | | | | | | | | | |
| Acetylenol E60 | 0.50 | 0.50 | 0.50 | 0.50 | 0.50 | 0.50 | 0.50 | 0.50 | 0.50 | 0.50 | 0.50 |
| lon-exchanged water | 24.45 | 24.45 | 19.45 | 19.45 | 22.45 | 19.45 | 21.95 | 33.46 | 22.45 | 19.45 | 18.44 |
| Titanium oxide particle content T(%) | 15.00 | 15.00 | 15.00 | 15.00 | 15.00 | 15.00 | 15.00 | 12.00 | 14.00 | 15.00 | 15.00 |
| Wax particle content W(%) | 2.00 | 2.00 | 2.00 | 2.00 | 2.00 | 2.00 | 1.00 | 2.00 | 0.80 | 1.00 | 3.40 |
| Resin particle content E(%) | 9.00 | 9.00 | 9.00 | 9.00 | 9.00 | 9.00 | 9.00 | 6.00 | 10.00 | 10.00 | 8.00 |
| Polyacrylic acid content A(%) | 0.05 | 0.05 | 0.05 | 0.05 | 0.05 | 0.05 | 0.05 | 0.04 | 0.05 | 0.05 | 0.06 |
| Water-soluble organic solvent content | 10.00 | 10.00 | 15.00 | 15.00 | 12.00 | 15.00 | 15.00 | 11.00 | 15.00 | 15.00 | 15.00 |
| S(%) | | | | | | | | | | | |
| Value of (E + W)/T (times) | 0.73 | 0.73 | 0.73 | 0.73 | 0.73 | 0.73 | 0.67 | 0.67 | 0.77 | 0.73 | 0.76 |
| Value of A/T (times) | 0.003 | 0.003 | 0.003 | 0.003 | 0.003 | 0.003 | 0.003 | 0.003 | 0.004 | 0.003 | 0.004 |
| Value of S/(T + E + W) (times) | 0.38 | 0.38 | 0.58 | 0.58 | 0.46 | 0.58 | 0.60 | 0.55 | 0.60 | 0.58 | 0.57 |
| Value of W/(E + W) (times) | 0.18 | 0.18 | 0.18 | 0.18 | 0.18 | 0.18 | 0.10 | 0.25 | 0.07 | 0.09 | 0.30 |
| Silica contributes to dispersion of | Yes | Yes | Yes | Yes | Yes | Yes | No | Yes | Yes | Yes | Yes |
| titanium oxide particle? | | | | | | | | | | | |

TABLE 8
Composition and properties of inks

| | Example | | | | | | | | | | |
|---|---|---|---|---|---|---|---|---|---|---|---|
| | 23 | 24 | 25 | 26 | 27 | 28 | 29 | 30 | 31 | 32 | 33 |
| Type of pigment dispersion liquid | 2 | 6 | 6 | 2 | 2 | 2 | 2 | 7 | 2 | 2 | 2 |
| Pigment dispersion liquid | 35.00 | 37.50 | 37.50 | 24.00 | 25.00 | 50.00 | 51.00 | 41.80 | 41.80 | 37.50 | 37.50 |
| Aqueous dispersion liquid of resin | 17.50 | 22.50 | | 22.50 | 22.50 | 22.50 | 22.50 | 22.50 | 25.00 | 22.50 | 22.50 |
| particle 1 | | | | | | | | | | | |
| Aqueous dispersion liquid of resin | | | 22.50 | | | | | | | | |
| particle 2 | | | | | | | | | | | |
| Aqueous dispersion liquid of resin | | | | | | | | | | | |
| particle 3 | | | | | | | | | | | |
| Aqueous dispersion liquid of resin | | | | | | | | | | | |
| particle 4 | | | | | | | | | | | |
| Aqueous dispersion liquid of wax | 8.50 | 5.00 | | 7.50 | 7.50 | 5.00 | 5.00 | | 5.56 | 5.00 | 5.00 |
| particle 1 | | | | | | | | | | | |
| Aqueous dispersion liquid of wax | | | 5.00 | | | | | 5.00 | | | |
| particle 2 | | | | | | | | | | | |
| Aqueous dispersion liquid of wax | | | | | | | | | | | |
| particle 3 | | | | | | | | | | | |
| Aqueous dispersion liquid of wax | | | | | | | | | | | |
| particle 4 | | | | | | | | | | | |
| Polyacrylic acid (Mw 1,900, Na salt) | | | | | | | | | | 0.05 | |
| Polyacrylic acid (Mw 2,000, Na salt) | | | | | | | | | | | 0.05 |
| Polyacrylic acid (Mw 2,500, Na salt) | 0.05 | 0.05 | 0.05 | 0.05 | 0.05 | 0.05 | 0.05 | 0.06 | | | |
| Polyacrylic acid (Mw 6,000, Na salt) | | | | | | | | | | | |
| Polyacrylic acid (Mw 6,100, Na salt) | | | | | | | | | | | |
| 1,2-Butanediol | 15.00 | 15.00 | 15.00 | 15.00 | 15.00 | 15.00 | 15.00 | 16.67 | 16.67 | 15.00 | 15.00 |
| 1,2-Pentanediol | | | | | | | | | | | |
| 1,2-Hexanediol | | | | | | | | | | | |
| 2-Methyl-1,3-propanediol | | | | | | | | | | | |
| Ethylene glycol | | | | | | | | | | | |
| Diethylene glycol | | | | | | | | | | | |
| Triethylene glycol | | | | | | | | | | | |
| Propylene glycol | | | | | | | | | | | |
| 2-Pyrrolidone | | | | | | | | | | | |
| Glycerol | | | | | | | | | | | |
| Acetylenol E60 | 0.50 | 0.50 | 0.50 | 0.50 | 0.50 | 0.50 | 0.50 | 0.56 | 0.50 | 0.50 | 0.50 |
| Ion-exchanged water | 23.45 | 19.45 | 19.45 | 30.45 | 29.45 | 6.95 | 5.95 | 13.41 | 10.47 | 19.45 | 19.45 |
| Titanium oxide particle content T(%) | 14.00 | 15.00 | 15.00 | 9.60 | 10.00 | 20.00 | 20.40 | 16.72 | 16.72 | 15.00 | 15.00 |
| Wax particle content W(%) | 3.40 | 2.00 | 2.00 | 3.00 | 3.00 | 2.00 | 2.00 | 2.00 | 2.22 | 2.00 | 2.00 |
| Resin particle content E(%) | 7.00 | 9.00 | 9.00 | 9.00 | 9.00 | 9.00 | 9.00 | 9.00 | 10.00 | 9.00 | 9.00 |
| Polyacrylic acid content A(%) | 0.05 | 0.05 | 0.05 | 0.05 | 0.05 | 0.05 | 0.05 | 0.06 | 0.00 | 0.05 | 0.05 |
| Water-soluble organic solvent content | 15.00 | 15.00 | 15.00 | 15.00 | 15.00 | 15.00 | 15.00 | 16.67 | 16.67 | 15.00 | 15.00 |
| S(%) | | | | | | | | | | | |
| Value of (E + W)/T (times) | 0.74 | 0.73 | 0.73 | 1.25 | 1.20 | 0.55 | 0.54 | 0.66 | 0.73 | 0.73 | 0.73 |
| Value of A/T (times) | 0.004 | 0.003 | 0.003 | 0.005 | 0.005 | 0.003 | 0.002 | 0.004 | 0.000 | 0.003 | 0.003 |
| Value of S/(T + E + W) (times) | 0.61 | 0.58 | 0.58 | 0.69 | 0.68 | 0.48 | 0.48 | 0.60 | 0.58 | 0.58 | 0.58 |
| Value of W/(E + W) (times) | 0.33 | 0.18 | 0.18 | 0.25 | 0.25 | 0.18 | 0.18 | 0.18 | 0.18 | 0.18 | 0.18 |
| Silica contributes to dispersion of | Yes | Yes | Yes | Yes | Yes | Yes | Yes | Yes | Yes | Yes | Yes |
| titanium oxide particle? | | | | | | | | | | | |

TABLE 9
Composition and properties of inks

| | Example | | | | Comparative Example | | | | | | |
|---|---|---|---|---|---|---|---|---|---|---|---|
| | 34 | 35 | 36 | 37 | 1 | 2 | 3 | 4 | 5 | 6 | 7 |
| Type of pigment dispersion liquid | 2 | 2 | 2 | 2 | 8 | 2 | 2 | 2 | 2 | 9 | 10 |
| Pigment dispersion liquid | 37.50 | 37.50 | 37.50 | 37.50 | 37.50 | 35.00 | 27.50 | 37.50 | 25.00 | 25.00 | 30.00 |
| Aqueous dispersion liquid of resin | 22.50 | 22.50 | 22.50 | 22.50 | 22.50 | 13.00 | 15.00 | 22.50 | | 25.00 | 27.50 |
| particle 1 | | | | | | | | | | | |
| Aqueous dispersion liquid of resin | | | | | | | | | 10.00 | | |
| particle 2 | | | | | | | | | | | |
| Aqueous dispersion liquid of resin | | | | | | | | | | | |
| particle 3 | | | | | | | | | | | |
| Aqueous dispersion liquid of resin | | | | | | | | | | | |
| particle 4 | | | | | | | | | | | |
| Aqueous dispersion liquid of wax | 5.00 | 5.00 | 5.00 | 5.00 | 2.50 | 2.50 | 5.00 | 5.00 | 2.00 | 2.50 | |
| particle 1 | | | | | | | | | | | |
| Aqueous dispersion liquid of wax | | | | | | | | | | | |
| particle 2 | | | | | | | | | | | |
| Aqueous dispersion liquid of wax | | | | | | | | | | | |
| particle 3 | | | | | | | | | | | |
| Aqueous dispersion liquid of wax | | | | | | | | | | | |
| particle 4 | | | | | | | | | | | |
| Polyacrylic acid (Mw 1,900, Na salt) | | | | | | | | | | | |
| Polyacrylic acid (Mw 2,000, Na salt) | | | | | | | | | | | |
| Polyacrylic acid (Mw 2,500, Na salt) | | | 0.15 | 0.16 | 0.05 | 0.05 | | | | | |
| Polyacrylic acid (Mw 6,000, Na salt) | 0.05 | | | | | | | | | | |
| Polyacrylic acid (Mw 6,100, Na salt) | | 0.05 | | | | | | | | | |
| 1,2-Butanediol | 15.00 | 15.00 | 15.00 | 15.00 | 15.00 | 14.00 | 5.00 | 15.00 | 10.00 | 1.00 | |
| 1,2-Pentanediol | | | | | | | | | | | |
| 1,2-Hexanediol | | | | | | | | 3.00 | | | |
| 2-Methyl-1,3-propanediol | | | | | | | | 2.00 | | 2.00 | |
| Ethylene glycol | | | | | | | | | | | |
| Diethylene glycol | | | | | | | | | | | |
| Triethylene glycol | | | | | | | | | 10.00 | | |
| Propylene glycol | | | | | | | | | | | 8.00 |
| 2-Pyrrolidone | | | | | | | | | | 10.00 | 1.00 |
| Glycerol | | | | | | | | | | | 8.00 |
| Acetylenol E60 | 0.50 | 0.50 | 0.50 | 0.50 | 0.50 | 0.50 | 0.50 | 0.50 | 0.50 | 0.50 | 0.50 |
| Ion-exchanged water | 19.45 | 19.45 | 19.35 | 19.34 | 21.95 | 34.95 | 47.00 | 14.50 | 42.50 | 34.00 | 25.00 |
| Titanium oxide particle content T(%) | 15.00 | 15.00 | 15.00 | 15.00 | 15.00 | 14.00 | 11.00 | 15.00 | 10.00 | 10.00 | 12.00 |
| Wax particle content W(%) | 2.00 | 2.00 | 2.00 | 2.00 | 1.00 | 1.00 | 2.00 | 2.00 | 0.80 | 1.00 | 0.00 |
| Resin particle content E(%) | 9.00 | 9.00 | 9.00 | 9.00 | 67.50 | 5.20 | 6.00 | 9.00 | 4.00 | 10.00 | 11.00 |
| Polyacrylic acid content A(%) | 0.05 | 0.05 | 0.15 | 0.16 | 0.05 | 0.05 | 0.00 | 0.00 | 0.00 | 0.00 | 1.80 |
| Water-soluble organic solvent content | 15.00 | 15.00 | 15.00 | 15.00 | 15.00 | 14.00 | 5.00 | 20.00 | 20.00 | 13.00 | 17.00 |
| S(%) | | | | | | | | | | | |
| Value of (E + W)/T (times) | 0.73 | 0.73 | 0.73 | 0.73 | 4.57 | 0.44 | 0.73 | 0.73 | 0.48 | 1.10 | 0.92 |
| Value of A/T (times) | 0.003 | 0.003 | 0.010 | 0.011 | 0.003 | 0.004 | 0.000 | 0.000 | 0.000 | 0.000 | 0.150 |
| Value of S/(T + E + W) (times) | 0.58 | 0.58 | 0.58 | 0.58 | 0.18 | 0.69 | 0.26 | 0.77 | 1.35 | 0.62 | 0.74 |
| Value of W/(E + W) (times) | 0.18 | 0.18 | 0.18 | 0.18 | 0.01 | 0.16 | 0.25 | 0.18 | 0.17 | 0.09 | 0.00 |
| Silica contributes to dispersion of | Yes | Yes | Yes | Yes | No | Yes | Yes | Yes | Yes | No | No |
| titanium oxide particle? | | | | | | | | | | | |

### Evaluations

The inks prepared above were evaluated in terms of the following items. In an embodiment of the present disclosure, for the evaluation grades for the following items, “A” and “B” are defined as the acceptable grades and “C” is defined as the unacceptable grade. The evaluation results will be described in Table 10.

### Hiding Property

Such an ink prepared above was charged into an ink cartridge and the ink cartridge was set in an ink jet recording apparatus including a recording head configured to use thermal energy to eject the ink (trade name “PIXUS PRO-10S”, manufactured by CANON KABUSHIKI KAISHA). In EXAMPLES, a solid image recorded under the following conditions is defined as having a recording duty of 100%: ink droplets of about 3.8 ng are applied to 1/600 inches× 1/600 inches unit areas at a resolution of 1200 dpi such that applied dots do not overlap, in other words, a single dot is applied to each of quarter regions of a 1/600 inches× 1/600 inches unit area (about 3.8 ng per dot). The above-described ink jet recording apparatus was used to apply the reactive liquid to the entire surface of a transparent label sheet (trade name “Livasta PET50A”, manufactured by LINTEC Corporation) at a recording duty of 50%. Subsequently, two 16.2 mm×16.2 mm solid images having ink recording duties of 200% and 350% were recorded. At this time, the carriage was moved at a rate of 12.7 cm/s. After the ink was applied, without conveying the recording medium in the sub-scanning direction, hot air at 80° C. was blown from 10 mm above the recording medium for 10 seconds and subsequently the discharge operation was performed to record the evaluation image. The hot air was generated using a hot-air dryer (trade name “T.S.K Hot-air generator TSK-18”, manufactured by Kansai Electric Heat Corp.) and blown through a nozzle having a diameter of 4 mm at a flow rate of 30.0 m/s.

Note that the hot-air drying is not intended to completely dry the liquid components of the recorded images. The hot-air drying is a method of, in handling of the recording medium in the subsequent post-recording step, determining the time after which transfer from or missing in the image due to, for example, contact of the recording-medium sheet pressing part with the image no longer occurs; thus, the hot-air drying is performed under preliminary drying conditions. This preliminary drying facilitates handling of recording media, but affects fixability. Under such recording conditions, 10 evaluation images were continuously recorded.

The 10 evaluation images were placed in a thermostat at 80° C. for 6 minutes, to sufficiently dry the liquid components on the surfaces of the recording media. A spectrophotometer (trade name “CM-3600A”, manufactured by KONICA MINOLTA, INC.) was used to measure the hiding powers of the evaluation images and the hiding property of the images was evaluated in accordance with the following evaluation grades.
A: Of the images having an ink recording duty of 200%, at least one has a hiding power of 60% or more and, of the images having an ink recording duty of 350%, at least one has a hiding power of 60% or more.
B: The images having an ink recording duty of 200% all have a hiding power of less than 60% and, of the images having an ink recording duty of 350%, at least one has a hiding power of 60% or more.
C: All the images have a hiding power of less than 60%.

### Fixability

Under the same conditions as in the above-described hiding-property evaluation images, 10 solid images having dimensions of 16.2 mm×200 mm and an ink recording duty of 300% were continuously recorded. At this time, missing in the images caused by the conveying mechanism and transfer of the white ink to the unrecorded areas due to adhesion of the ink to the conveying mechanism were visually inspected to evaluate fixability in accordance with the following evaluation grades. In the cases of occurrence of missing in or transfer from the images, the images are not sufficiently dried and the images should have been subjected to, for example, another drying, which means that the images have low fixability.
AA: For all the 10 images, no missing in the images was observed and furthermore at least one image has no transfer marks.
A: Of the 10 images, missing in an image is observed in at least one image; however, there are no images in which both of missing and transfer marks in the images are observed.
B: Of the 10 images, in at least one image, both of missing and transfer marks in the image are observed.
C: For all the 10 images, both of missing and transfer marks in the images are observed.

### Scratch Resistance

A 32 mm×200 mm solid image having an ink recording duty of 300% was recorded under the same conditions as in the above-described hiding-property evaluation images except that the drying using the hot-air dryer was not performed. This solid image was placed in an oven at 80° C. for 6 minutes to sufficiently dry the liquid components on the surface of the recording medium, to provide an evaluation image. The evaluation image was subjected to a test of performing to-and-fro movements for 300 cycles at the maximum using a color fastness rubbing tester (trade name “JIS L 0849 Gakushin-Type II”, manufactured by DJK) and a 50×50 mm cloth cut from trade name “Test White Fabric-Cotton (canequim No. 3)” (manufactured by JSA GROUP), under a test load of 500 g. The rubbing rate was 30 cycles/min. Every 100 cycles, the wear of the image was visually inspected and the scratch resistance of the image was evaluated in accordance with the following evaluation grades.
A: No wear of the image is observed even after the test for 300 cycles or wear of the image is observed after the test for 300 cycles while no wear of the image is observed after the test for 100 cycles and 200 cycles.
B: Wear of the image is observed after the test for 200 cycles while no wear of the image is observed after the test for 100 cycles.
C: Wear of the image is observed after the test for 100 cycles.

TABLE 10
Evaluation results

| | | Hiding | | Scratch |
|---|---|---|---|---|
| | | property | Fixability | resistance |
| Example | 1 | A | AA | A |
| | 2 | A | AA | A |
| | 3 | A | AA | A |
| | 4 | A | AA | A |
| | 5 | A | AA | A |
| | 6 | A | AA | A |
| | 7 | A | AA | A |
| | 8 | A | AA | A |
| | 9 | A | AA | A |
| | 10 | A | AA | A |
| | 11 | A | AA | A |
| | 12 | A | A | A |
| | 13 | A | A | A |
| | 14 | A | A | A |
| | 15 | A | B | A |
| | 16 | A | B | A |
| | 17 | A | AA | A |
| | 18 | A | B | A |
| | 19 | B | AA | B |
| | 20 | A | AA | B |
| | 21 | A | AA | A |
| | 22 | A | AA | A |
| | 23 | A | AA | B |
| | 24 | A | AA | B |
| | 25 | A | AA | B |
| | 26 | B | AA | A |
| | 27 | A | AA | A |
| | 28 | A | AA | A |
| | 29 | B | AA | A |
| | 30 | B | AA | A |
| | 31 | B | AA | A |
| | 32 | B | AA | A |
| | 33 | A | AA | A |
| | 34 | A | AA | A |
| | 35 | B | AA | A |
| | 36 | A | AA | A |
| | 37 | B | AA | A |
| Comparative | 1 | C | AA | C |
| Example | 2 | C | AA | C |
| | 3 | C | AA | B |
| | 4 | A | A | C |
| | 5 | C | C | C |
| | 6 | B | C | B |

The evaluation result of Example 24 in terms of scratch resistance was “B” as in Example 25, but Example 24 had higher scratch resistance. The evaluation results of Examples 32 and 35 in terms of the hiding property were “B” as in Example 31, but Examples 32 and 35 had better hiding properties.

The present disclosure provides a titanium oxide-containing aqueous ink for ink jet recording in which fixability, a hiding property and scratch resistance are all sufficient, an ink cartridge and an ink jet recording method that use the aqueous ink.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-052458, filed Mar. 28, 2023 and Japanese Patent Application No. 2024-030008, filed Feb. 29, 2024, which are hereby incorporated by reference herein in their entirety.

What is claimed is:

1. An aqueous ink for ink jet recording comprising a titanium oxide particle, a resin particle and a water-soluble organic solvent,
wherein the titanium oxide particle comprises titanium oxide having a surface at least a portion of which is covered with alumina and silica and
in the aqueous ink, a content of the titanium oxide particle (T (% by mass)), a content of the resin particle (E (% by mass)) and a content of the water-soluble organic solvent (S (% by mass)) satisfy relations of a formula (1) and a formula (2) below:
$$E / T \geq 0.5 \qquad ( 1 )$$
$$0.3 \leq S / ( T + E ) \leq 0.7 . \qquad ( 2 )$$

2. The aqueous ink according to claim 1, wherein the titanium oxide particle is dispersed by at least an action of the silica.

3. The aqueous ink according to claim 1, wherein the resin particle is formed of acrylic resin.

4. The aqueous ink according to claim 1, wherein the resin particle includes a wax particle and a mass ratio of a content of the wax particle (% by mass) to the content of the resin particle in the aqueous ink is 0.09 times or more to 0.30 times or less.

5. The aqueous ink according to claim 4, wherein a volume-based 50% cumulative particle size of the titanium oxide particle (D_{T} (nm)), a volume-based 50% cumulative particle size of the resin particle (D_{E} (nm)) and a volume-based 50% cumulative particle size of the wax particle (D_{W} (nm)) satisfy relations of a formula (3) and a formula (4) below:
$${D}_{W} \geq {D}_{E} \qquad ( 3 )$$
$${D}_{T} \geq 2 \times {D}_{E} . \qquad ( 4 )$$

6. The aqueous ink according to claim 1, wherein, in the aqueous ink, the content of the titanium oxide particle (% by mass) is 10.00% by mass or more to 20.00% by mass or less based on a total mass of the ink.

7. The aqueous ink according to claim 1, wherein the water-soluble organic solvent includes at least one selected from the group consisting of 1,2-butanediol, 1,2-pentanediol and propylene glycol.

8. The aqueous ink according to claim 1, further comprising a compound represented by a general formula (1) below: 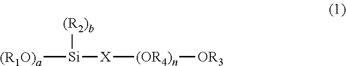
in the general formula (1), R₁, R₂ and R₃ each independently represent a hydrogen atom or an alkyl group having 1 to 4 carbon atoms, R₄ is an alkylene group having 2 to 4 carbon atoms, X is a single bond or an alkylene group having 1 to 6 carbon atoms, n is 6 to 24, a is 1 to 3, b is 0 to 2 and a+b=3.

9. The aqueous ink according to claim 1, further comprising a polyacrylic acid having a weight-average molecular weight of 2,000 or more to 6,000 or less and a mass ratio of a content of the polyacrylic acid (% by mass) to the content of the titanium oxide particle (% by mass) is 0.010 times or less.

10. An ink cartridge comprising an ink and an ink storage portion storing the ink,
wherein the ink comprises the aqueous ink according to claim 1.

11. An ink jet recording method of recording an image onto a recording medium by ejecting an ink from an ink jet recording head,
wherein the ink comprises the aqueous ink according to claim 1.
